(19) United States
(12) Patent Application Publication
(10) Pub. No.: US 2010/0088394 A1
(43) Pub. Date: Apr. 8, 2010

(54) MULTIPOINT PUBLISHING

(76) Inventors: FRANK BARBIERI, Santa Monica, CA (US); Alan Westenbroek, Barcelona (ES)

Correspondence Address: DLA PIPER US LLP, 1999 AVENUE OF THE STARS, SUITE 400, LOS ANGELES, CA, 90067-6023, US

(21) Appl. No.: 12/553,065

(22) Filed: Sep. 2, 2009

Related U.S. Application Data
(60) Provisional application No. 61/093,712, filed on Sep. 2, 2008.

(51) Int. Cl. G06F 15/16

(52) U.S. Cl. 709/217

(57) ABSTRACT

The present system provides for the ability to automatically transmit and publish media content to desired locations. The locations can include computers, mobile devices, and web pages as desired. The system can be an automatic system, a push system, or a pull system as configured by user selection. Content files are automatically transcoded to the proper format depending on the destination of the content.

This patent application claims priority to provisional patent application 61/093,712 filed Sep. 2, 2008 which is incorporated herein in its entirety.

### BACKGROUND OF THE SYSTEM

There is a large library of video and other media available on the internet today. In addition, more media is being added on a daily basis. Much of the media is stored as Flash or other file formats and stored on Web servers for use by web plug-ins on sites such as YouTube, Break.com, and MySpace Video. These same sites are generating thousands of new tiles of media content daily. The ability to watch and share media on the internet has become a popular habit and users expect to continue to be able to view media content on other web enabled devices, such as PDA's and mobile phones.

As the proliferation of this digital content, and specifically video, explodes online and on mobile phones, consumers are collecting and accessing video content across a number of disparate devices and channels. Today, these channels are often isolated. For instance, video uploaded to the web by a consumer is only available for web viewing, not viewing on a mobile phone. Video uploaded via a mobile phone is only viewable on other mobile phones with the same capabilities. This leads to isolated systems in which consumers must access video uploading, sharing and viewing in different ways depending on which device they are using. The result is video captured on mobile phones is not generally and easily available on the web, and video uploaded or captured on the web is not generally and easily available on mobile phones.

There are some existing solutions in market that capture short form video from cell phones, know as MMS—Multimedia Messaging Service—and publish it on the web. An Example is Veeker.com. There are also existing solutions that provide for the access of online video from mobile phones. For example Zannel.com.

The primary problem with the current approaches is that they a) only contemplate one way delivery, for instance mobile to web or web to mobile, and/or b) do not enable high quality and high fidelity sharing. For instance MMS is limited to short clips, less than 30 seconds.

### BRIEF SUMMARY OF THE SYSTEM

The present system provides for the ability to automatically transmit and publish media content to a plurality of desired locations. The locations can include computers, mobile devices, and web pages as desired. The system can be an automatic system, a push system, or a pull system as configured by user selection. Content files are automatically transcoded to the proper format depending on the destination of the content.

### BRIEF DESCRIPTION OF THE DRAWINGS

FIG. 1 is a block diagram illustrating an embodiment of the system.

FIG. 2 is a block diagram illustrating the multipoint publishing system.

FIG. 3 is a flow diagram illustrating set up of rules for publishing.

FIG. 4 is a flow diagram illustrating operation of an embodiment of the system.

FIG. 5 is an example computer environment for implementing the system.

### DETAILED DESCRIPTION OF THE SYSTEM

The system enables the capture, sharing and delivery of high fidelity video from multiple kinds of devices and platforms to multiple kinds of devices and platforms. For instance a consumer can capture a long form and high quality video on their mobile phone, upload it into the system, and the video can be automatically published to multiple and disparate devices and platforms (for instance—online, broadcast and other mobile phones). Multiple users can upload multiple videos to the system at the same time and aggregate that video around selected distribution channels and platforms. For instance every consumer with the system at a concert can upload a video of that concert from their cell phones and the system will automatically aggregate and distribute those videos online, on broadcast systems and/or on other mobile phones. The system in one embodiment uses an http upload to get the video in the system either via mobile phone or online properties accessed via a desktop computer.

In one embodiment, the system contemplates the publishing of multimedia content captured via mobile phone. However, the system has equal application to content captured by any means, such as a cell phone, other portable web enabled device, or any other content capturing device or system. In addition, the system in described in connection with video content, but has equal application with audio content, still images, or any combination of content.

The system allows a user to set distribution rules on the destination of uploaded videos. Users can set rules based on their account with the system, or may use tags or keywords associated with the metadata of that video to determine distribution rules. For instance a user can upload a video from a mobile phone with a tag association that says “MySpace” and that video can be automatically sent to the user's MySpace page, and/or published on a television channel or set-top box, and/or published out to other cell phones.

The system can also automatically and in real-time transcode and optimize that video for the selected distribution platform. So the device that receives the video receives the best quality video that device can handle.

The system can deliver alerts or e-mails notifying individuals (users and non-users of the system) that video is available for viewing. For instance a user can upload a video into the system from a cell phone with a tag of “mom” and the system will automatically send the user's mother a text message and/or and e-mail to the user's mother's cell phone or desktop computer that alerts her to the availability of a new video to view.

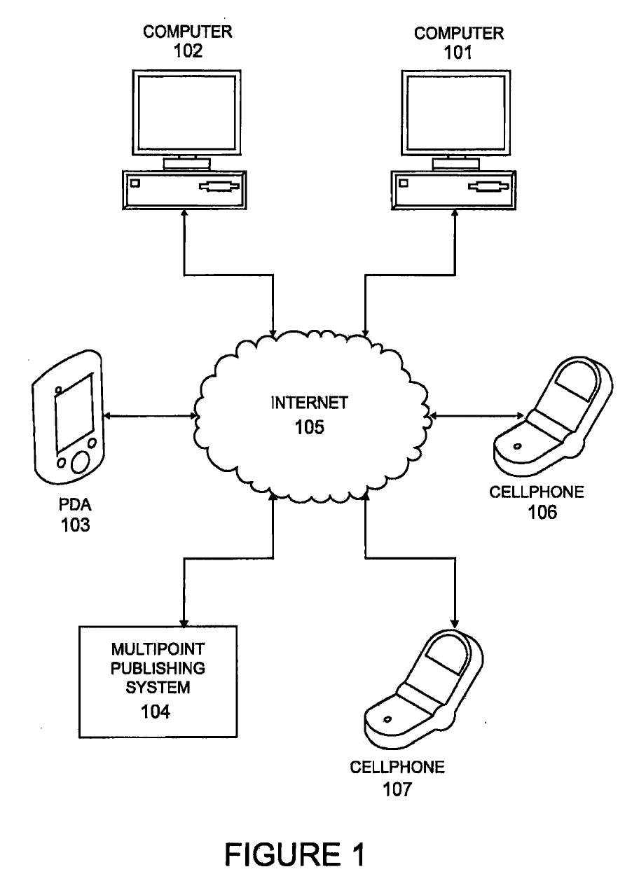

FIG. 1 illustrates an embodiment of the system. The system contemplates a plurality of devices that can create and/or view video content connected to a network such as the internet 105 and/or cellular networks. The devices include mobile phones 106 and 107, computers 101 and 102, and web enabled PDA 103. When a video is made on cell phone 106. for example, it is uploaded via the cellular network or the internet to multipoint publishing system 104. There, based on user preferences of the sender and/or receiver, it is transcoded as appropriate and published to one or more destinations in one or more protocols and formats. For example, the video from phone 106 can be automatically sent to cell phone 107, PDA 103 and computer 101 as desired. If each of those destinations requires a different protocol, then transcoding is applied to the content to transform the content into the proper protocol for use on the destination device.

In addition, an alert can be provided to computer 102 that a video is available for viewing from phone 106. As noted above, the video could also be posted automatically to a web based account (e.g. myspace) and if desired, alerts can be sent to selected users who can then access the video using the platform of their choice.

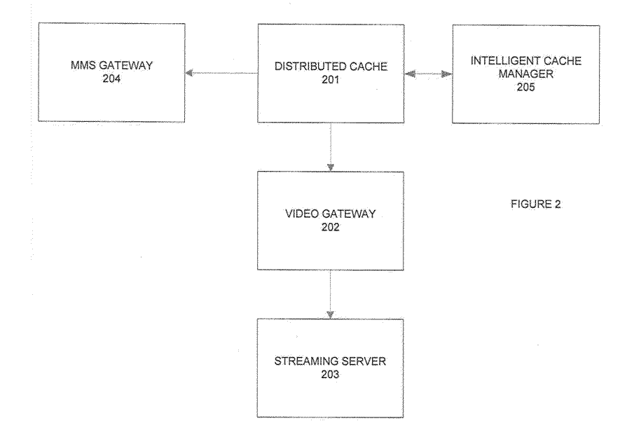

FIG. 2 is a block diagram illustrating the functions of the multipoint publishing system of block 104. A Distributed Cache 201 maintains copies of encoded video files and their associated metadata so they are available for immediate delivery to the requesting devices. The Video Gateway 202 determines the appropriate server and format for each incoming video request, based upon network, device, and connection.

The Streaming Server 203 uses, for example, RTSP and HTTP protocols to deliver bandwidth-appropriate streams to the mobile devices that include built-in support for it, on networks capable of RTSP streaming and HTTP progressive download for networks with firewalls or other configurations the prevent streaming.

The MMS Gateway 204 provides for truncated MMS delivery of video when for network or device reasons streaming is not an option.

An Intelligent Cache Manager 205 works in concert with real-time feedback from the Video Gateways distributed around the network to control the retention and expiration of cached content. This assures that popular content will remain instantly available for the networks and geographic areas that require it. The Intelligent Cache Manager 205 also is used to pre-fetch, encode, and cache related content with appropriate metadata before it is requested.

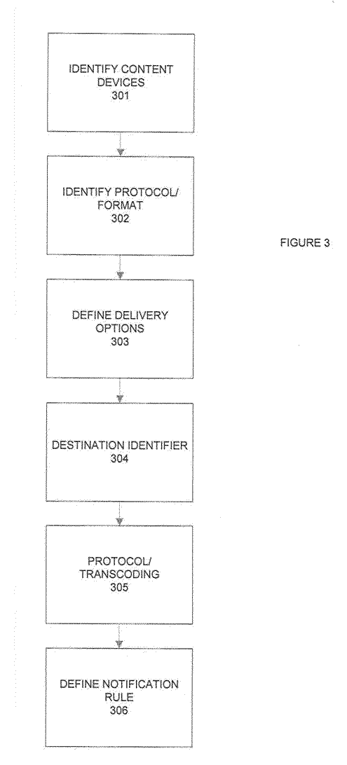

FIG. 3 is a flow diagram illustrating the definition of preferences by a user of the system. At step 301 the user identifies one or more devices on which the user may capture or create content. For each device, at step 302, the user identifies the protocol and format of the content that is created or captured by the device. At step 303, for each device, the user defines delivery options for content published to the system. These rules include an address of a receiving destination. For example, it may be a code for a cellular phone, an email address, a URL, a social network account, an instant messaging address, or the like. At step 304, the system requests the user to provide a destination identifier (i.e. destination name) to be associated with the particular delivery rules. This enables the user to identify multiple sets of rules and destinations for each content creation device. A user may define any number of destination names, such as “friends”, “family”, “work”, “MySpace”, “Facebook”, etc. When a user of the system wishes to publish content, it can select as a destination one of the destination names that will then control the publication of the content. At step 305 the system determines protocols and transcoding requirements for each receiving destination and associates them with the destinations in a database.

At step 306, the user also elects a notification rule for each destination associated with each destination name. The user may wish some or all of the destinations to be notified of the publication of new content. The notification for each destination may include multiple paths and types of notice, including email, voicemail, SMS messaging. Twitter, etc, and each type of notice may be made to multiple addresses.

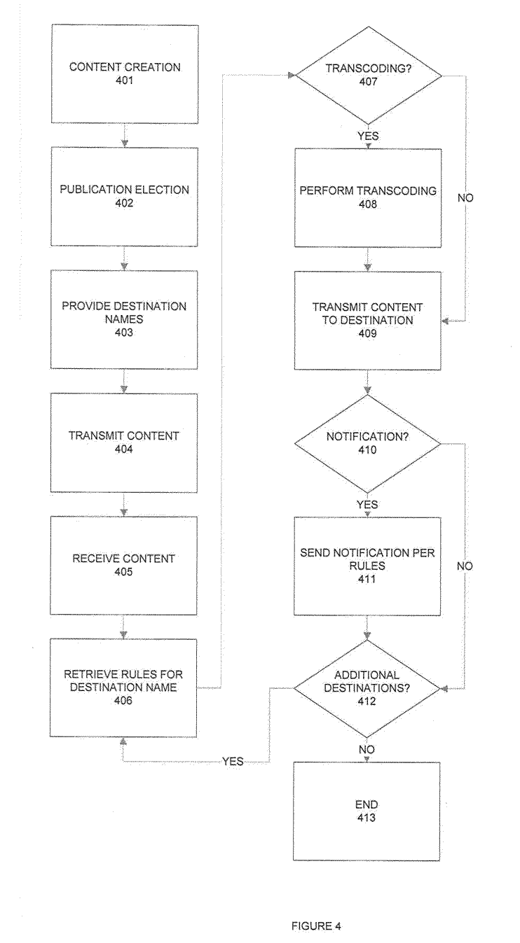

FIG. 4 is a flow diagram illustrating the operation of the system when content is created. At step 401 a user creates or captures content. It should be noted that the term “capture” herein includes the receipt of content by the user from other users, from web sites, from uploading of content in other formats, and/or the generation of content using, for example, a video camera feature on a device.

At step 402 the user elects to publish the content. At step 403 the system requests the selection of one or more destination identifiers for publication of the data. After selection, the user transmits the content at step 404. At step 405 the content is provided to the multipoint publishing system 104, along with metadata about the content format and the destination identifiers of step 403.

At step 406, the system retrieves the rules associated with the destination identifier. At step 407 the system determines if trranscoding is required for any destination identified in the rules. If so, at step 408, transcoding is performed as appropriate. If not, or after step 408, the system transmits the content to the receiving destinations at step 409. At step 410, it is determined if notification is required for any of the receiving destinations. If so, the system sends the appropriate notifications based on the rules for that destination at step 411.

If not, the system checks at step 412 for any additional destination identifiers. If there is another destination identifier, the system returns to step 406. If not, the system ends at step 413.

Embodiment of Computer Execution Environment (Hardware)

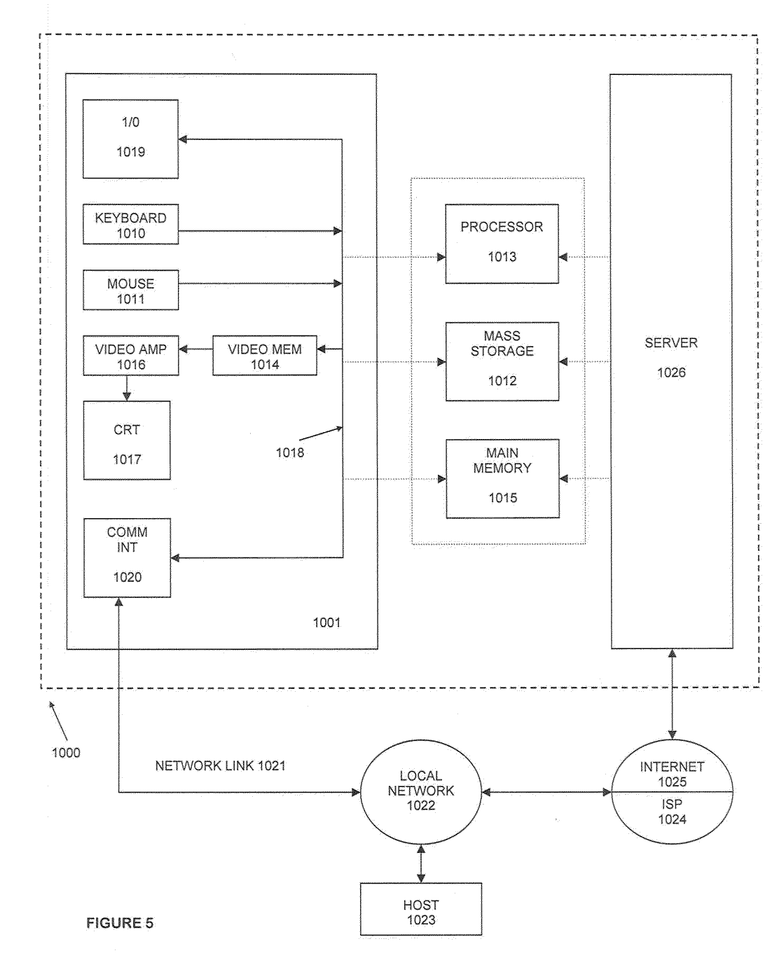

An embodiment of the system can be implemented as computer software in the form of computer readable program code executed in a general purpose computing environment such as environment 500 illustrated in FIG. 5, or in the form of bytecode class tiles executable within a Java™ run time environment running in such an environment, or in the form of bytecodes running on a processor (or devices enabled to process bytecodes) existing in a distributed environment (e.g., one or more processors on a network). A keyboard 510 and mouse 511 are coupled to a system bus 518. The keyboard and mouse are for introducing user input to the computer system and communicating that user input to central processing unit (CPU 513. Other suitable input devices may be used in addition to, or in place of, the mouse 511 and keyboard 510. I/O (input/output) unit 519 coupled to bi-directional system bus 518 represents such I/O elements as a printer, A/V (audio/video) I/O, etc.

Computer 501 may include a communication interface 520 coupled to bus 518. Communication interface 520 provides a two-way data communication coupling via a network link 521 to a local network 522. For example, if communication interface 520 is an integrated services digital network (ISDN) card or a modem, communication interface 520 provides a data communication connection to the corresponding type of telephone line, which comprises part of network link 521. If communication interface 520 is a local area network (LAN) card, communication interface 520 provides a data communication connection via network link 521 to a compatible LAN. Wireless links are also possible. In any such implementation, communication interface 520 sends and receives electrical, electromagnetic or optical signals which carry digital data streams representing various types of information.

Network link 521 typically provides data communication through one or more networks to other data devices. For example, network link 521 may provide a connection through local network 522 to local server computer 523 or to data equipment operated by ISP 524. ISP 524 in turn provides data communication services through the world wide packet data communication network now commonly referred to as the “Internet” 525. Local network 522 and Internet 525 both use electrical, electromagnetic or optical signals which carry digital data streams. The signals through the various networks and the signals on network link 521 and through communication interface 520, which carry the digital data to and from computer 500, are exemplary forms of carrier waves transporting the information.

Processor 513 may reside wholly on client computer 501 or wholly on server 526 or processor 513 may have its computational power distributed between computer 501 and server 526. Server 526 symbolically is represented in FIG. 5 as one unit, but server 526 can also be distributed between multiple “tiers”. In one embodiment, server 526 comprises a middle and back tier where application logic executes in the middle tier and persistent data is obtained in the back tier. In the case where processor 513 resides wholly on server 526, the results of the computations performed by processor 513 are transmitted to computer 501 via Internet 525, Internet Service Provider (ISP) 524, local network 522 and communication interface 520. In this way, computer 501 is able to display the results of the computation to a user in the form of output.

Computer 501 includes a video memory 514, main memory 515 and mass storage 512, all coupled to bi-directional system bus 518 along with keyboard 510, mouse 511 and processor 513.

As with processor 513. in various computing environments, main memory 515 and mass storage 512, can reside wholly on server 526 or computer 501, or they may be distributed between the two. Examples of systems where processor 513, main memory 515, and mass storage 512 are distributed between computer 501 and server 526 include the thin-client computing architecture developed by Sun Microsystems, Inc., the palm pilot computing device and other personal digital assistants, Internet ready cellular phones and other Internet computing devices, and in platform independent computing environments, such as those which utilize the Java technologies also developed by Sun Microsystems, Inc.

The mass storage 512 may include both fixed and removable media, such as magnetic, optical or magnetic optical storage systems or any other available mass storage technology. Bus 518 may contain, for example, thirty-two address lines for addressing video memory 514 or main memory 515. The system bus 518 also includes, for example, a 32-bit data bus for transferring data between and among the components, such as processor 513, main memory 515, video memory 514 and mass storage 512. Alternatively, multiplex data/address lines may be used instead of separate data and address lines.

In one embodiment of the invention, the processor 513 is a microprocessor such as manufactured by Intel, AMD, Sun. etc. However, any other suitable microprocessor or microcomputer may be utilized. Main memory 515 is comprised of dynamic random access memory (DRAM). Video memory 514 is a dual-ported video random access memory. One port of the video memory 514 is coupled to video amplifier 516. The video amplifier 516 is used to drive the cathode ray tube (CRT) raster monitor 517. Video amplifier 516 is well known in the art and may be implemented by any suitable apparatus. This circuitry converts pixel data stored in video memory 514 to a raster signal suitable for use by monitor 517. Monitor 517 is a type of monitor suitable for displaying graphic images.

Computer 501 can send messages and receive data, including program code, through the network(s), network link 521, and communication interface 520. In the Internet example, remote server computer 526 might transmit a requested code for an application program through Internet 525, ISP 524, local network 522 and communication interface 520. The received code maybe executed by processor 513 as it is received, and/or stored in mass storage 512, or other non-volatile storage for later execution. In this manner, computer 500 may obtain application code in the form of a carrier wave. Alternatively, remote server computer 526 may execute applications using processor 513, and utilize mass storage 512, and/or video memory 515. The results of the execution at server 526 are then transmitted through Internet 525, ISP 524, local network 522 and communication interface 520. In this example, computer 501 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

What is claimed is:

1. A method for automatically publishing content comprising:
creating content;
uploading the content to a publishing system;
transcoding the content for a destination system;
transmitting the transcoded content to the destination system.

2. The method of claim 1 wherein the transmitting of content to the destination system is pursuant to pre-existing rules defined by a user.

3. The method of claim 2 further including the step of sending a notification of the transmitting of content to the destination system.

4. The method of claim 3 wherein the destination system is a mobile phone.

5. The method of claim 3 wherein the destination is a social networking web site.
